(19) United States
(12) Patent Application Publication
(10) Pub. No.: US 2018/0101586 A1
(43) Pub. Date: Apr. 12, 2018

(54) INDEXING AND RETRIEVAL OF A LARGE NUMBER OF DATA OBJECTS

(71) Applicant: Facebook, Inc., Menlo Park, CA (US)

(72) Inventors: Yiqiang Mao, Seattle, WA (US); Xiaolin Xie, Kirkland, WA (US); Liangxiao Zhu, Redmond, WA (US)

(21) Appl. No.: 15/289,789

(22) Filed: Oct. 10, 2016

(51) Int. Cl. G06F 17/30; G06F 3/06

(52) U.S. Cl. CPC G06F 17/30575; G06F 17/30371; G06F 3/067; G06F 3/0619; G06F 3/064; G06F 17/30339

(57) ABSTRACT

A data structure with large amount of data is organized such that each entry is a data object having a plurality of indexing fields that contain derived data from data sources that are constantly updated. To update the data structure with minimal latency, a system retrieves data from the data sources and stores the data in indexing fields of a data object. To allow different users to modify their own draft versions of the data structure, the system stores the user's changes for each modified data object. Each user's own view is then generated by modifying the data structure based on the user's stored changes. The system pre-computes derived data for data objects by detecting changes in data sources and identifies which fields in the data structure were affected by changes. The system accesses logic for computing the derived data to update fields in the data structure.

### BACKGROUND

This disclosure relates generally to managing a large amount of data, and more specifically to indexing and retrieval of a large number of data objects.

An online system, such as a social networking system, allows its users to connect to and communicate with other online system users. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Online services, such as social networking systems, search engines, news aggregators, Internet shopping services, and content delivery services, have become a popular venue for presenting content to social networking system users. A user (e.g., content provider) often manages a large number of data objects (e.g., content items). For example, the user sorts and filters the data objects based on certain criteria. In addition, the user may generate large sets of draft data objects before placing the data objects into a production, such as before a content provider provides content items for presentation to social networking system users. Each data object may comprise various fields that correspond to different features retrieved from different data sources. For example, a content item can be represented as a data object comprising various features, such as information related to an available budget, one or more objectives, targeting criteria, a delivery status, user engagement data, a name, available resources, etc., which may originate from various data sources. Thus, millions of data objects (content items) commonly managed by a content provider can account for huge amount of data to be retrieved from different data sources.

A user interface operated by a user may display millions of data objects utilizing, for example, a user management page. For displaying large amount of data objects on the user management page, the user interface may load at once all the data objects into a memory of a social networking system. However, due to a large amount of data objects commonly managed by the user, the social networking system may run out of memory when displaying data objects on the user management page. In addition, a latency of retrieving huge amount of data objects from various data sources is prohibitively high.

### SUMMARY

A system presented herein includes a user interface for displaying a data structure or a table. Each entry in the data structure can be associated with a data object (e.g., a content item), and each data object comprises a plurality of fields that contain derived data from a plurality of data sources that are constantly updated. To enable the user interface to update a display (e.g., upon filtering or re-sorting the data structure or table displayed at the user interface) with a minimal latency, the system retrieves data from each of a plurality of separate data sources and stores the data for each data object in the data structure organized by data objects. This enables the system to search a smaller data space when computing the derived data for each data object in the data structure. To allow different users (e.g., content providers) to modify their own draft versions, the system stores the user's changes as a set of fields for each user for each modified data object along with a bitmask indicating what was modified in that data object. Each user's own view is then generated by modifying the data structure based on the user's stored changes. The system also pre-computes derived data (e.g., for content items) by detecting one or more changes in one or more data sources of the plurality of data sources, using a data dependency graph to identify which fields of a data object were affected by changes in the data sources. The system then accesses logic for computing the derived data to obtain one or more updated fields in the data structure.

A system presented in this disclosure generates a data structure based on relating each data object of a plurality of data objects with each entry of a plurality of entries of the data structure, wherein each entry for each data object comprises a plurality of indexing fields. The system derives data from a plurality of data sources, wherein a different data source of the plurality of data sources is associated with a different indexing field of that data object. The system retrieves the data derived from the plurality of data sources for storing into the data structure such that data derived from a different data source is included in a different indexing field of that data object. The system displays, at a user interface, the data structure organized by the plurality of data objects comprising the data derived from the plurality of data sources. The system monitors the plurality of data sources for changes in one or more of the plurality of data sources. The system updates, based on the changes in the one or more data sources, indexing fields of each data object in the data structure, wherein a different field of the indexing fields is updated with data derived from a different data source. The system further updates the displaying of the data structure at the user interface by including the updated fields of each data object in the data structure.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a block diagram of a system environment with a user interface for managing a large amount of data, in accordance with an embodiment.

FIG. 4 is an example of a data structure having large amount of data displayed at a user interface of the system shown in FIG. 3, in accordance with an embodiment.

FIG. 5 is an example of per-user changes in the data structure shown in FIG. 4, in accordance with an embodiment.

FIG. 6 illustrates an example of data dependency graph related to the data structure shown in FIG. 4, in accordance with an embodiment.

FIG. 7 is a flowchart of a method for managing a large amount of data in a data structure displayed at a user interface, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

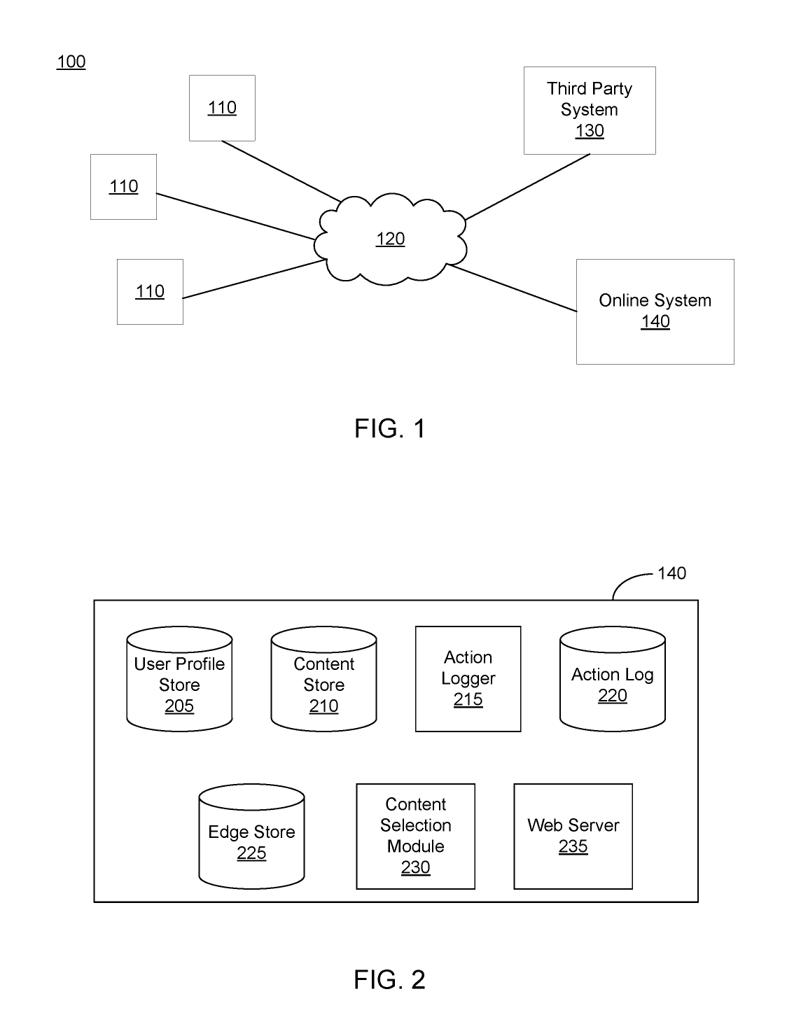

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as content items, content, or information about an application provided by the third party system 130.

In some embodiments, one or more of the third party systems 130 provide content items to the online system 140 for presentation to users of the online system 140. A content item includes any kind of content that can be presented online. The content item can be text, image, audio, video, or any other suitable data presented to an online user. The content item may also include a landing page specifying a network address to which a user is directed when the content item is accessed. In an embodiment, a third party system 130 may provide compensation to the online system 140 in exchange for presenting a content item. Content presented by the online system 140 for which the online system 140 receives compensation in exchange for presenting is referred to herein as “sponsored content,” or “sponsored content items.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged and stored in the user profile of the user. A user profile in the user profile store 205 may also maintain references to actions by the corresponding user performed on content items in the content store 210 and stored in the action log 220.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

The content selection module 230 selects one or more content items for communication to a client device 110 to be presented to a user. Content items eligible for presentation to the user are retrieved from the content store 210, or from another source by the content selection module 230, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items selected for presentation to the user may include sponsored content items associated with bid amounts. The content selection module 230 uses the bid amounts associated with content items when selecting content for presentation to the viewing user. In various embodiments, the content selection module 230 determines an expected value associated with various sponsored content items based on their bid amounts and selects sponsored content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content from the content item. The content selection module 230 may rank sponsored content items based on their associated bid amounts and select sponsored content items having at least a threshold position in the ranking for presentation to the user. In some embodiments, the content selection module 230 ranks both content items not associated with bid amounts and sponsored content items in a unified ranking based on bid amounts associated with sponsored content items and measures of relevance associated with content items. Based on the unified ranking, the content selection module 230 selects content for presentation to the user. Selecting content items through a unified ranking is further described in U.S. patent application Ser. No. 13/545,266, filed on Jul. 10, 2012, which is hereby incorporated by reference in its entirety.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Data Search: Indexing and Retrieval

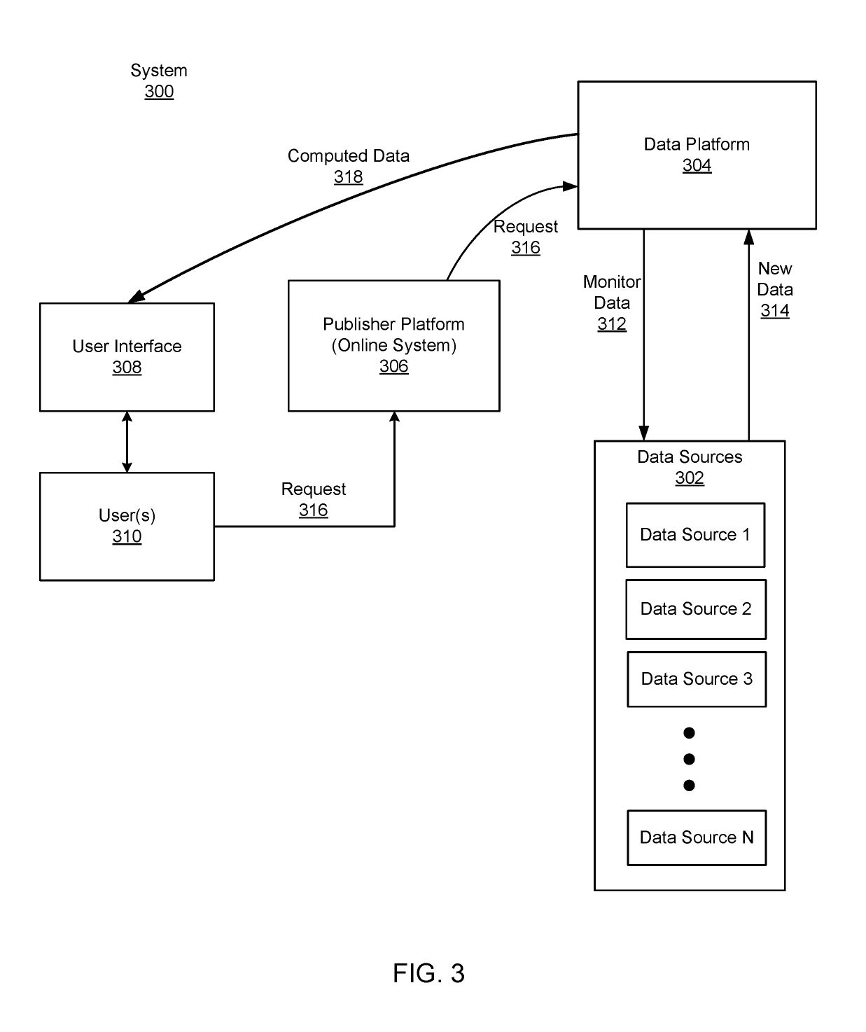

FIG. 3 is a block diagram of a system environment 300 for managing a large amount of data, such as content items, in accordance with an embodiment. The system environment 300 comprises a plurality of data sources 302 coupled to a data platform 304, a publisher platform 306, and a user interface 308 operated by one or more users 310. The publisher platform 306 is an embodiment of the online system 140. In some embodiments, each user 310 coupled to the publisher platform 306 represents a content provider 310 that manages large amount of data (content items) at the user interface 308.

In some embodiments, the data platform 304 monitors 312 data from the data sources 302. As discussed in more detail below, when changes in the data sources 302 occur, the data platform retrieves new data 314 from at least one data source 302 to be re-computed at the data platform 304. A user 310 may manage a data structure comprising a large amount of data, which is displayed at the user interface 308. The user 310 may send a request 316 to a publisher platform 306 requesting data update for the data structure displayed at the user interface 308. Upon receiving the request 310, the publisher platform 306 forwards the request 316 to the data platform 304 that is configured to be always up-to-date in relation to data 314 from the plurality of data sources 302. Therefore, upon receiving the request 310, the data platform 304 provides updated re-computed data 318 to the user(s) 310 to be displayed within the data structure at the user interface 308.

In some embodiments, the data structure displayed at the user interface 308 may comprise a table with a large number of data objects managed by the user(s) 310, each data object comprising a plurality of fields and occupies an entry in the table. In an embodiment, each data object in the data structure may be a content item object or content item. Thus, the data structure or table may comprise a large number of content items managed by a content provider 310. For example, for some embodiments, a number of content items in the data structure may be in the range of millions of content items. In addition, each content item object in the data structure comprises various types of data that originate from various different data sources 302, such as: one or more objectives in relation to the content item, targeting criteria, a delivery status, user engagement data, a name of the content item, available resources, a budget, etc.

For managing (e.g., sorting/filtering) a large amount of data displayed at the user interface 308, all the data may be loaded at once into a memory of the system environment 300 (e.g., a memory of PHP layer in the publisher platform 306 or the online system 140). However, due to a large size of the data, the system environment 300 may run out of memory. In addition, a latency of retrieving huge amount of the data from a large number of different data sources 302 is prohibitively high.

In some embodiments, a data structure (table) displayed at the user interface 308 and managed by the user 310 (e.g., content provider) can be organized as a plurality of data objects (e.g., content item objects). Each data object occupies one table entry and can be divided (indexed) into a plurality of fields. Each index or field in a data object represents a portion of a data object that is associated with a particular data source 302. Different portions (indexes or fields) of a data object comprise different data types and originate from different data sources 302. By organizing the data structure in this way, the user 310 can quickly perform sorting and filtering of a large number of data objects, whereas updating and retrieving of data coming from various different data sources 302 can be performed in real time.

When a content provider 310 creates a content item, data related to that newly created content item are typically stored in different databases, i.e., the data of the new content item are retrieved from different data sources 302. The newly created content item is organized in the data structure displayed at the user interface 308 as a content item object with indexed portions (fields), whereas each field in a content item object comprises data associated with a different data source 302, i.e., there is a mapping between an index of a content item object in the data structure and a data source 302. It is therefore desirable to closely monitor the data sources 302 for data updates that can be directly mapped to indexed portions (fields) of one or more content item objects in the data structure. In some embodiments, the data platform 304 continuously monitors changes in the data sources. In an embodiment, the data platform 304 is configured to monitor log files in the data sources 302 for changes in the data sources 302.

In some embodiments, data from different data sources 302 are continuously updated. In an embodiment, even without query from the user 310, the data structure displayed at the user interface 308 is updated. Thus, the data structure may be continuously updated even without a filtering/sorting command or any other command from the user 310. To refresh the data structure displayed at the user interface 308 in real time, data from the data sources 302 can be pre-processed at the data platform 304 when changes occur in the data sources 302. The data platform 304 may monitor changes in the data sources 302 in background, and always re-compute data upon the changes in the data sources 302. In this way, the data platform 304 is always up-to-date in relation to newly re-computed data 318, and can continuously forward the re-computed data 318 to the user interface 308 for displaying within the data structure.

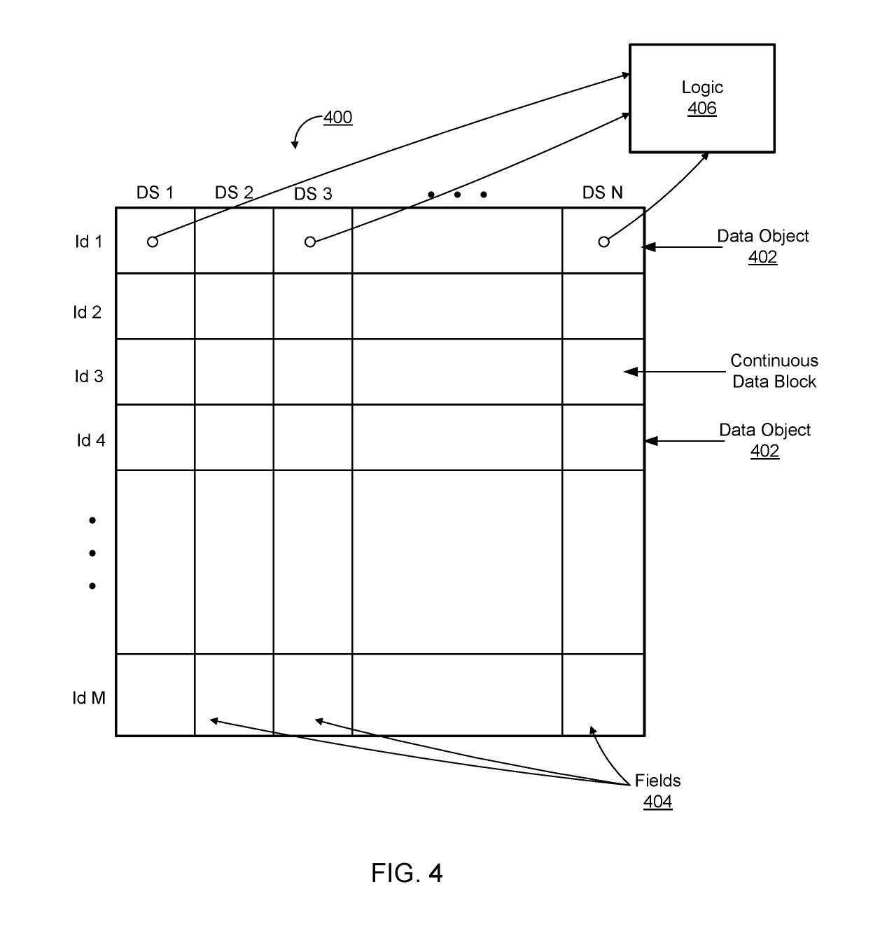

FIG. 4 is an example of a data structure or table 400 that may be displayed at the user interface 308, in accordance with an embodiment. In some embodiments, as discussed, the data structure 400 comprises a plurality of data objects 402, each data object 402 is a continuous data block that occupies one entry in the data structure 400 and can be indexed into a plurality of portions or fields 404. Each field 404 in a data object 402 comprises data of a specific type that originate from a different data source 402. In an embodiment, a data object 402 is a content item object or a content item.

In some embodiments, data within the data structure 400 are distributed at different data sources 302. Pulling all data from different data sources 302 at once to refresh displaying of the data structure 400 at the user interface 308 takes a certain amount of time that is typically longer than a desired latency. Therefore, the data structure 400 is organized such that each field or indexed portion 404 of a data object 402 is updated based on changes in a particular data source 302. Partitioning of a data object 402 into a plurality of fields 404 results into data indexing, wherein each data index or indexed portion (field) 404 in a data object 402 is mapped to a unique data source 302 thus facilitating data update in real time upon changes in a specific subset of the data sources 302. Thus, the data structure 400 represents a table with a plurality of entries occupied by a plurality of data objects 402, wherein each data object 402 includes data aggregated from various different data sources 302 indexed into a plurality of fields 404 that are individually updated upon changes in corresponding data sources 302.

In some embodiments, logic 406 shown in FIG. 4 is configured for re-computing data to be populated into fields 404 of a data object 402 in the data structure 400. In an embodiment, the logic 406 is a part of PHP layer of the publisher platform 306 and the online system 140. In another embodiment, the logic 406 is included in the data platform 304. Since data related to different data sources 302 are continuously (often and repeatedly) changing, the logic 406 for re-computing new data to be populated into various fields 404 in different data objects 402 is also changing frequently. Thus, the logic 406 is chosen on the fly based on a subset of fields 404 that is re-calculated at a given time instant.

As illustrated in FIG. 4, each data object 402 comprises a continuous data block (e.g., 20 bytes of data). In some embodiments, a continuous data block of each data object 402 is stored in a fixed memory buffer. A plurality of data objects 402 of the data structure 400 are stored in a memory block comprising a plurality of memory buffers. In an embodiment, the memory block is a part of a storage medium of the user interface 308. In another embodiment, the memory block is a part of storage medium of the data platform 304. Thus, each data object 402 represents a continuous data block partitioned into a plurality of indexed portions or fields 404, wherein a specific index (portion or field) of the continuous data block is mapped to a particular data source 302. Each data object 402 in the data structure 400 can be updated based on mapping between particular bytes of that data object and a specific subset of the data sources 302. This allows efficient (real time) updating of different indexing portions (fields) of a data object 402, whereas data related to each data object 402 in the data structure 400 are stored in a memory in a compact manner, providing a compact storage of the entire data structure 400 and real time updating of the data structure 400.

In some embodiments, as discussed, upon changes in the data sources 302, the data platform 304 re-computes new data for data objects 402 in the background before being displayed at the user interface 308 within the data structure or table 400, even without any (refresh) command from the user 310. In an embodiment, the logic 406 is part of the data platform 304 and can be chosen on fly based on a specific subset of fields 404 that is being updated, i.e., based on changes in a specific subset of the data sources 302. Flexibility in choosing the logic 406 for re-computing new data allows optimized updating of a specific subset of fields 404 in one or more data objects 402.

Embodiments of the present disclosure include methods performed by the system environment 300 for efficient data retrieval and efficient data update from various different data sources 302. In some embodiments, the data platform 304 obtains updates 314 from the data sources 302 continuously and consistently in real time by constantly monitoring for changes in the data sources 302. For example, when a content provider 310 creates a content item, it is desirable that this newly created content item appears in the system environment 300 (e.g., at the online system 308 and/or the user interface 308) within a small latency (e.g., 1-2 seconds). When a content item is created, log files associated with the content item are also created in different data sources 302. Thus, to achieve data retrieval from various different data sources 302 with a small latency, the data platform 304 continuously monitors log files for changes in the data sources 302. In this way, the data platform 304 is able to continuously and with a low latency re-compute all the latest information related to the data sources 302.

Embodiments of the present disclosure further include methods for storing large amounts of data that may be performed by the system environment 300 so as to achieve fast data retrieval from various data sources 302. In some embodiments, as discussed, all data related to a content item are aggregated under a same data object (content item object) 402 in the data structure 400. Thus, when changes occur in the data sources 302, the system environment 300 can efficiently pinpoint indexed portions or fields 404 in a data object 402 that should be updated, which is mapped to updating certain bytes in a memory buffer that stores a continuous data block of a data object 402.

In some embodiments, as discussed, each data object 402 is associated with a different content item, which may be created by the user 310 (e.g., content provider). Each data object 402 is indexed, such that a first index is associated with a first field 404 of that data object 402, the first field 404 comprising data associated with a first data source of the plurality of data sources 302; a second index is associated with a second field 404 of the same data object 402, the second field 404 comprising data associated with a second data source of the plurality of data sources 302. In some embodiments, as discussed, choosing of the logic 406 for re-computing new data at a given time instant is flexible and based on a specific subset of fields 404 in one or more data object 402 that are being updated. Data in the subset of fields 404 previously computed are overwritten with newly re-computed data. The logic 406 for re-computing data associated with various fields 404 in one or more data objects 402 may vary frequently. Each field 404 in the data structure 400 is re-computed/updated on fly very quickly because data are efficiently organized based on indexing within the data structure 400.

Embodiments of the present disclosure further include methods for interpreting large amounts of data coming from various different data sources 302. In some embodiments, data originating from the data sources 302 may include raw data at the data sources 302 and computed data shown within the data structure or table 400. In some embodiments, after monitoring for changes in raw data in the data sources 302, the changed raw data are pulled into the data platform 304 for re-computation. The data platform 304 sends the re-computed data 318 to the user interface 308, and stores all computed data in an organized way based on indexing to be presented at the user interface 308 within the data structure 400. The re-computing (updating) of data fields 404 can be performed in real time since the re-computing is based on pulling data from the data platform 304 that continuously monitors in the background changes in the data sources 302. The logic 406 within the data platform 304 that re-computes data associated with data fields 404 is customized for these specific data fields 404.

### Per-User Draft Search

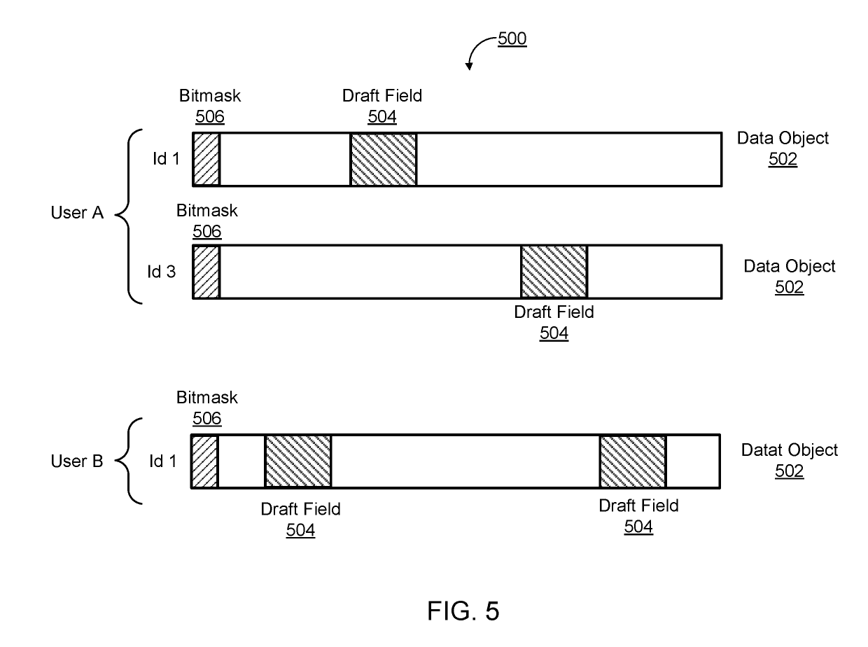

FIG. 5 is an example 500 of per-user changes in the data structure 400 displayed at the user interface 308. In some embodiments, a user 310 (e.g., content provider) can create a large set of content items that are not yet in production (i.e., draft content items). The draft content items can be located, for example, in a working version to which a user can return to in some time in the future. Methods of the present disclosure in relation to the data structure 400 allow multiple users to work simultaneously on modifications of same data objects 402 in the data structure 400, wherein each user has its own view of data objects independent of other users, i.e., its own independent view of the data structure 400. For example, in a draft mode, a user 310 may change one field 404 of a data object 402 (e.g., a name of a content item). However, this change of field 404 may not be visible to other users that can make their own changes to the same data object 402 (e.g., the content item). Thus, different users 310 can make different changes to a same data object 402 in the data structure 400. However, each other changes are not visible to other users. A user 310 can search data objects 402 in the data structure 400 by draft fields 404 (e.g., names of content item objects given only by that user), without searching any field changes made by other users. In this way, multiple users can simultaneously work on the same data structure 400 at the user interface 308 using the same account, but not affecting other users' work. This approach is especially valuable when a user makes significant amount of changes, but, however, the user did not finish all changes. Other users however cannot see the user's changes until the changes are saved at the user interface 308. In some embodiments, per user search of content item objects can be conducted on both saved content item objects and draft content item objects.

FIG. 5 shows a draft version 500 of the data structure 400 for two different users 310, in accordance with an embodiment. One user (e.g., user A in FIG. 5) can change one or more data objects 502 by creating draft versions of one or more fields 504 associated with the one or more data objects 502. Each data object 502 in FIG. 5 can correspond to a draft version of a data object 402 of the data structure 400 in FIG. 4. As illustrated in FIG. 5, for user A, one or more bitmasks 506 are created indicating the changed one or more draft versions of the one or more fields 504. In an embodiment, each bitmask 506 can be associated with a different data object 502 that is being modified, indicating what fields 504 are changed in that particular data object 502. In some embodiments, the user interface 308 stores, in a memory allocated to user A, the changed one or more draft versions of one or more fields 504 and the one or more bitmasks 506. Thus, only the changed fields 504 are stored in the memory. The user interface 308 further generates, for user A, a view of the data structure 400 by modifying the data structure 400 with the stored one or more draft versions of one or more fields 504 and the one or more bitmasks 506. Thus, the view of the data structure 400 specific for user A may be obtained by replacing one or more fields 404 in the data structure 400 with one or more draft versions of one or more fields 504 based on the one or more bitmasks 506 for the one or more data objects 502.

As further illustrated in FIG. 5, another user (e.g., user B) can change the same one or more data objects 502 by creating its own draft versions of one or more fields 504 and at least one bitmask 506. Then, the user interface 308 stores, in a memory allocated to user B, user B's own draft versions of one or more fields 504 and the at least one bitmask 506. The user interface 308 further generates, for user B, user B's own view of the data structure 400 by modifying the data structure 400 with the stored one or more draft versions of one or more fields 504 and the at least one bitmask 506. A view of the data structure 400 for one user is thus independent of a view of the data structure 400 for the other user. Therefore, data search (e.g., content item search) for one user (content provider) 310 can be performed on a search domain different than a domain for data search for other user 310.

### Data Platform for Pre-Processing Data

Referring back to FIG. 3, the system environment 300 based on the data platform 304 interfaced to the plurality of data sources 302 can be applied for pre-processing of new data upon changes in the data sources 302. Due to a large number of data sources 302, there is a prohibitively high latency if data from the different data sources 302 are re-computed at once for refreshing the data structure 400. In addition, computing power and resources can be wasted whenever the data structure 400 having a large number of data objects 402 (e.g., content items) is loaded/re-loaded for displaying at the user interface 308. Instead, it is desirable to continuously load approximately same amount of data from different data sources 302 for re-loading (refreshing) the data structure 400 in real time.

In some embodiments, the data platform 304 monitors data 312 in the data sources 302, i.e., the data platform 304 monitors 312 for changes in the data sources 302, which represents a push model of the system environment 300. Upon new data 314, i.e., when the data platform 304 registers changes in data from one or more of the data sources 302, the data platform 304 re-computes data 318 that are affected by change(s) in the one or more data sources 302. In an embodiment, a pulling model is changed to a push model by monitoring changes from the data sources 302. Thus, the data platform 304 continuously updates data when changes in the data sources 302 happen. The online system 306 may forward the request 316 for new data from the user 310 to the data platform 304. The data platform 304 may re-compute new data 318 and provide the newly re-computed data 318 to the user interface 308 to be displayed at the user interface 308 as the data structure 400.

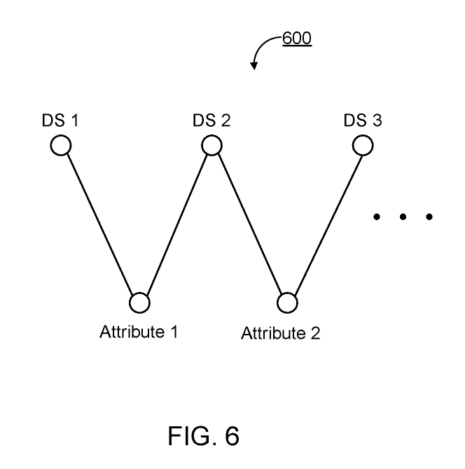

In some embodiments, the data platform 304 monitors for changes in the data sources 302. Upon changes in the data sources 302 occur, the data platform 304 may check a data dependency graph stored at the data platform 304 to determine which attributes of data object 402 in the data structure 400 are affected by changes in the data sources 302. The data dependency graph provides information about relation between the data sources 302 and attributes (i.e., fields 404) of a data object 402 in the data structure 400. FIG. 6 illustrates an example of data dependency graph 600 that may be stored at the data platform 304, in accordance with an embodiment. As shown by the data dependency graph 600, if changes are only in a first data source of the plurality of data sources 302 (i.e., in data source DS1), only a first attribute is re-computed; if changes are in a second data source and in a third data source of the plurality of data sources 302 (i.e., in data sources DS2 and DS3), only a second attribute is re-computed. Thus, only a limited number of attributes of a data object 402 in the data structure 400 is re-computed every time changes occur in the data sources 302.

The data platform 304 ensures that the data dependency graph 600 is always up-to-date. In some embodiments, the data platform 304 may consult PHP layer logic at the online system 306 (e.g., publisher platform) on how to compute certain attributes of the data structure 400 upon occurrence of changes in the data sources 302. Referring back to FIG. 6, PHP layer logic may provide information on how to compute a first attribute from a first and second of the data sources 302; PHP layer logic may further provide information on how to compute a second attribute from a second and third of the data sources 302, and so on. In some embodiments, the data platform 304 always performs in background monitoring for changes in the data sources 302 and re-computing attributes upon changes in the data sources 302. Thus, the data platform 304 maintains up-to-date data attributes for the data structure 400.

Upon a user 310 issues the request 316 for updating attributes in the data structure 400, the publisher platform 306 forwards the request 316 to query the data platform 304, which is always up-to-date in relation to the new data 314. The data platform 304 sends re-computed data (attributes) 318 associated with change(s) in one or more data sources 302 to the user interface 308. In this way, a latency of re-loading the data structure 400 with large amount of data is within a desired threshold. Furthermore, same data attributes are not re-computed multiple times, i.e., data attributes are re-computed only upon the request 316 from the user 310.

### Operations for Managing Large Amount of Data

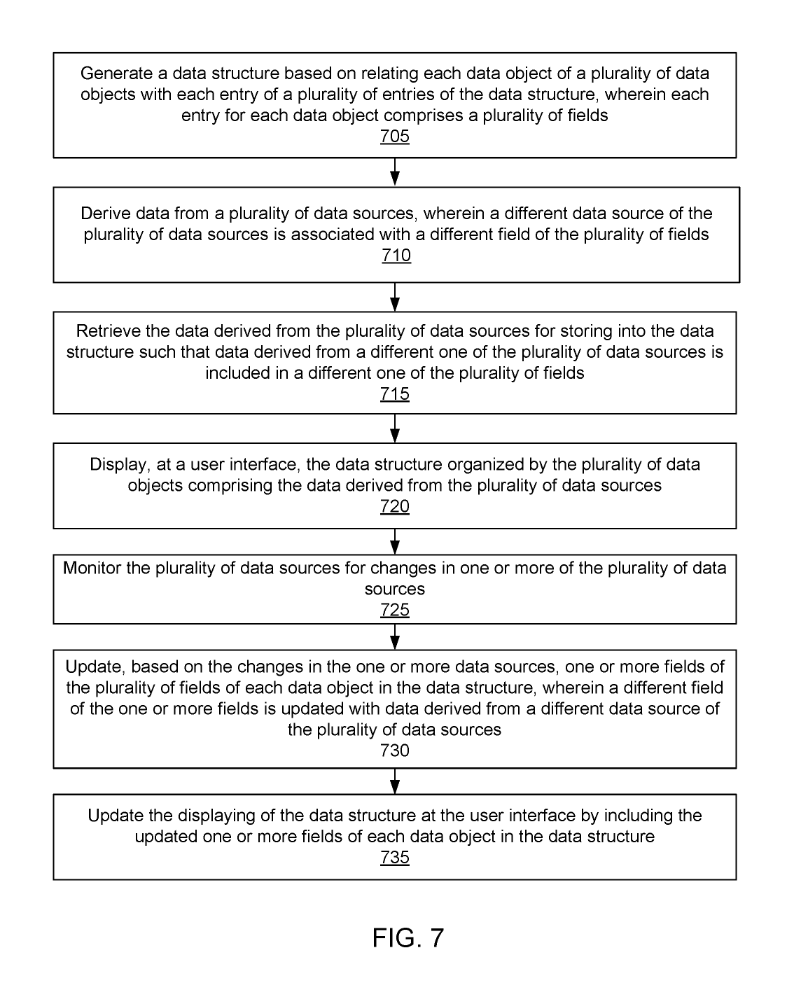

FIG. 7 is a flowchart of one embodiment of a method for managing a large amount of data in a data structure displayed at a user interface. In various embodiments, the steps described in conjunction with FIG. 7 may be performed in different orders than the order described in conjunction with FIG. 7. Additionally, the method may include different and/or additional steps than those described in conjunction with FIG. 7 in some embodiments.

The system 300 in FIG. 3 generates 702 a data structure (e.g., the data structure 400 shown in FIG. 4) based on relating each data object of a plurality of data objects (e.g., data objects 402) with each entry of a plurality of entries of the data structure, wherein each entry for each data object comprises a plurality of fields (e.g., fields 404). In some embodiments, each data object comprises a content item object (or content item), and plurality of data objects may comprise a plurality of content items objects managed by a content provider (e.g., the user 310).

The system 300 derives 704 (e.g., via the data platform 304) data from a plurality of data sources (e.g., the data sources 302). In some embodiments, a different data source of the plurality of data sources is associated with a different field of the plurality of fields in the data structure.

The system 300 retrieves 706 (e.g., via the data platform 304, the online system 306 and the user interface 308) the data derived from the plurality of data sources for storing into the data structure. In some embodiments, data derived from a different one of the plurality of data sources is included in a different one of the plurality of fields in the data structure.

The system 300 displays 708 (e.g., via the user interface 308) the data structure organized by the plurality of data objects comprising the data derived from the plurality of data sources.

The system 300 monitors 710 (e.g., via the data platform 304) the plurality of data sources for changes in one or more of the plurality of data sources. Upon the changes in the one or more data sources, the data platform receives new relevant data (e.g., the data 314) from the one or more data sources. The data platform re-computes (derives), based on the received new relevant data, data for at least one field of the plurality of fields of that data object in the data structure.

The system 300 updates 712 (e.g., via the logic 406 at the data platform 304) one or more fields of the plurality of fields of each object in the data structure, based on the changes in the one or more data sources. In some embodiments, a different field of the one or more fields is updated with data derived from a different data source of the plurality of data sources.

The system 300 updates 714 (e.g., via the user interface 308) the displaying of the data structure at the user interface by including the updated one or more fields of each data object in the data structure.

### Additional Configuration Information

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
generating a data structure based on relating each data object of a plurality of data objects with each entry of a plurality of entries of the data structure, wherein each entry for each data object comprises a plurality of fields;
deriving data from a plurality of data sources, wherein a different data source of the plurality of data sources is associated with a different field of the plurality of fields;
retrieving the data derived from the plurality of data sources for storing into the data structure such that data derived from a different one of the plurality of data sources is included in a different one of the plurality of fields;
displaying, at a user interface, the data structure organized by the plurality of data objects comprising the data derived from the plurality of data sources;
monitoring the plurality of data sources for changes in one or more of the plurality of data sources;
updating, based on the changes in the one or more data sources, one or more fields of the plurality of fields of each data object in the data structure, wherein a different field of the one or more fields is updated with data derived from a different data source of the plurality of data sources; and
updating the displaying of the data structure at the user interface by including the updated one or more fields of each data object in the data structure.

2. The method of claim 1, further comprising:
changing, for a user of a plurality of users, one or more draft versions of one or more fields associated with one or more data objects of the plurality of data objects in a draft version of the data structure for the user;
generating, for the user, one or more bitmasks indicating the changed one or more draft versions of one or more fields for the user, each of the one or more bitmasks is associated with a different data object of the one or more data objects;
storing, for the user, the changed one or more draft versions of one or more fields for that user and the one or more bitmasks; and
generating, for the user, a view of the data structure at the user interface based on modifying the data structure with the stored one or more draft versions of one or more fields and the one or more bitmasks for the user.

3. The method of claim 1, further comprising:
upon determining the changes in the one or more data sources, determining at least one field of at least one data object of the plurality of data objects in the data structure affected by the changes in the one or more data sources, based on a dependency graph relating each field in each data object of the data structure with at least one data source of the plurality of data sources;
computing data associated with the affected at least one field of the at least one data object in the data structure;
receiving a request from the user to update the displaying of the data structure at the user interface; and
upon the request, updating the displaying of the data structure at the user interface by modifying the data structure based on the computed data associated with the affected at least one field of the at least one data object in the data structure.

4. The method of claim 1, wherein generating the data structure comprises:
generating the data structure based on relating each content item object of the plurality of data objects with each entry of the plurality of entries of the data structure, and wherein each content item object comprises the plurality of fields.

5. The method of claim 1, further comprising:
storing each data object of the plurality of data objects in the data structure as a continuous data block in a memory buffer of the data platform; and
storing the plurality of data objects in a plurality of memory buffers of a memory block of the data platform.

6. The method of claim 1, further comprising:
selecting a logic for updating the one or more fields based on the one or more fields of the plurality of fields of each data object in the data structure to be updated.

7. The method of claim 1, wherein monitoring the plurality of data sources for changes in one or more of the plurality of data sources comprises:
monitoring log files for new data in the one or more data sources.

8. The method of claim 1, wherein monitoring the plurality of data sources for changes in one or more of the plurality of data sources comprises:
receiving new data from the one or more data sources, upon changes in the one or more data sources; and
re-computing, based on the received new data, data for at least one field of the plurality of fields of that data object in the data structure.

9. A system comprising:
a user interface configured to display a data structure organized based on relating each data object of a plurality of data objects with each entry of a plurality of entries of the data structure, wherein each entry for each data object comprises a plurality of fields;
a plurality of data sources; and
a data platform coupled to the plurality of data sources configured to
derive data from the plurality of data sources for displaying within the data structure at the user interface, a different data source of the plurality of data sources is associated with a different field of the plurality of fields,
retrieve the data derived from the plurality of data sources for storing into the data structure such that data derived from a different one of the plurality of data sources is included in a different one of the plurality of fields,
monitor the plurality of data sources for changes in one or more of the plurality of data sources, and
update, based on the changes in the one or more data sources, one or more fields of the plurality of fields of each data object in the data structure, a different field of the one or more fields is updated with data derived from a different data source of the plurality of data sources, and
the user interface is further configured to update the displaying of the data structure by including the updated one or more fields of each data object in the data structure.

10. The system of claim 9, wherein:
a user of a plurality of users changes, via the user interface, one or more draft versions of one or more fields associated with one or more data objects of the plurality of data objects in a draft version of the data structure for the user, and
the user interface is further configured to:
generate, for the user, one or more bitmasks indicating the changed one or more draft versions of one or more fields for the user, each of the one or more bitmasks is associated with a different data object of the one or more data objects,
store, for the user in a memory of the user interface, the changed one or more draft versions of one or more fields for the user and the one or more bitmasks, and
generate, for the user, a view of the data structure at the user interface based on modifying the data structure with the stored one or more draft versions of one or more fields and the one or more bitmasks for the user.

11. The system of claim 9, further comprising:
a publisher platform coupled to the user interface and the data platform, wherein
upon determining the changes in the one or more data sources, the data platform is further configured to
determine at least one field of at least one data object of the plurality of data objects in the data structure affected by the changes in data, based on a dependency graph in the data platform relating each field in each data object of the data structure with one or more data sources of the plurality of data sources, and
compute data associated with the affected at least one field of the at least one data object in the data structure, based on a logic of the publisher platform,
the publisher platform is configured to receive a request from the user to update the displaying of the data structure at the user interface and to forward the request to the data platform,
the user interface is further configured to receive, from the data platform based on the request, the computed data associated with the affected at least one field of the at least one data object in the data structure, and
upon reception of the computed data, the user interface is further configured to update the displaying of the data structure by modifying the data structure based on the computed data associated with the affected at least one field of the at least one data object in the data structure.

12. The system of claim 9, wherein:
the user interface is further configured to display the data structure organized based on relating each content item object of the plurality of data objects with each entry of the plurality of entries of the data structure, wherein each content item object comprises the plurality of fields.

13. The system of claim 9, further comprises:
a memory block of the data platform organized as a plurality of memory buffers, each memory buffer storing a different data object of the plurality of data objects as a continuous data block.

14. The system of claim 9, wherein:
the logic of the publisher platform is based on the one or more fields of the plurality of fields of each data object in the data structure to be updated.

15. The system of claim 9, wherein:
the data platform is further configured to monitor log files for new data in the one or more data sources.

16. The system of claim 9, wherein:
the data platform is further configured to receive new data from the one or more data sources, upon changes in the one or more data sources; and
the data platform is further configured to re-compute, based on the received new data, data for at least one field of the plurality of fields of that data object in the data structure.

17. A computer program product comprising a computer-readable storage medium having instructions encoded thereon that, when executed by a processor, cause the processor to:
generate a data structure based on relating each data object of a plurality of data objects with each entry of a plurality of entries of the data structure, wherein each entry for each data object comprises a plurality of fields;
derive data from a plurality of data sources, wherein a different data source of the plurality of data sources is associated with a different field of the plurality of fields;
retrieve the data derived from the plurality of data sources for storing into the data structure such that data derived from a different one of the plurality of data sources is included in a different one of the plurality of fields;
display, at a user interface, the data structure organized by the plurality of data objects comprising the data derived from the plurality of data sources;
monitor the plurality of data sources for changes in one or more of the plurality of data sources;
update, based on the changes in the one or more data sources, one or more fields of the plurality of fields of each data object in the data structure, wherein a different field of the one or more fields is updated with data derived from a different data source of the plurality of data sources; and
update the displaying of the data structure at the user interface by including the updated one or more fields of each data object in the data structure.

18. The computer program product of claim 17, wherein generate the data structure comprises:
generate the data structure based on relating each content item object of the plurality of data objects with each entry of the plurality of entries of the data structure, and wherein each content item object comprises the plurality of fields.

19. The computer program product of claim 17, wherein the instructions further cause the processor to:
store each data object of the plurality of data objects in the data structure as a continuous data block in a memory buffer of the data platform; and
store the plurality of data objects in a plurality of memory buffers of a memory block of the data platform.

20. The computer program product of claim 17, wherein monitor the plurality of data sources for changes in one or more of the plurality of data sources comprises:
receive new data from the one or more data sources, upon changes in the one or more data sources; and
re-compute, based on the received new data, data for at least one field of the plurality of fields of that data object in the data structure.
